(19) United States
(12) Patent Application Publication
(10) Pub. No.: US 2018/0210267 A1
(43) Pub. Date: Jul. 26, 2018

(54) DISPLAY MODULE AND METHOD FOR FITTING THE SAME

(71) Applicant: Zhenzhen Zhang, Wuhan, Hubei (CN)

(72) Inventor: Zhenzhen Zhang, Wuhan, Hubei (CN)

(73) Assignee: Wuhan China Star Optoelectronics Technology Co., Ltd., Wuhan, Hubei (CN)

(21) Appl. No.: 15/327,221

(22) PCT Filed: Dec. 27, 2016
(86) PCT No.: PCT/CN2016/112425

§ 371 Date: Jan. 18, 2017

(30) Foreign Application Priority Data
Dec. 21, 2016 (CN) 201611189840.2

(51) Int. Cl. G02F 1/1333; F21V 8/00; G02F 1/1335

(52) U.S. Cl. CPC G02F 1/133308; G02B 6/0055; G02F 2001/133325; G02F 1/133514; G02F 2202/28; G02F 1/133528

(57) ABSTRACT

Disclosed is a display module, which relates to the technical field of liquid crystal display. The display module includes, from bottom to top, a backlight unit and a liquid crystal unit that are combined together by a wrapping tape. A projection of an outline of the backlight unit on the liquid crystal unit overlaps an outline of the liquid crystal unit. Thus, a size of the outline of the backlight unit is the same as a size of the outline of the liquid crystal unit. There is no longer a sealant frame that makes an edge of the backlight module exceed an edge of the liquid crystal unit. The narrow-bezel design is thus realized. Meanwhile, a distance between the outline of the backlight unit and an edge of the display area is increased, and thus light leakage from the backlight unit is avoided. When the liquid crystal unit and the backlight unit are fitted together with no gap therebetween, a thickness of the display module is reduced, and the narrow-bezel and thin design of the display module is realized.

### CROSS-REFERENCE TO RELATED APPLICATIONS

This application claims the priority of Chinese patent application CN 201611189840.2, entitled “Display Module and Method for Fitting the Same” and to filed on Dec. 21, 2016. the entirety of which is incorporated herein by reference.

### FIELD OF THE INVENTION

The present disclosure relates to the technical field of liquid crystal display, and in particular, to a display module and a method for fitting the same.

### BACKGROUND OF THE INVENTION

Liquid crystal display devices (LCD) are different from self-luminous cathode ray tube (CRT) display devices and plasma display panels (PDP). Because liquid crystals themselves do not emit light, an external light source is indispensable for display. A light source located at the back of a display screen is called a backlight. According to the positional relationship between a light source (e.g., a fluorescent light source, an LED (light-emitting diode) light source, and an electro-luminescent light source) and a light guide plate, backlights can be divided into under-set and side-set backlights. An under-set backlight is capable of achieving high light utilization rate and large area lighting, but its brightness is not that uniform and it has a large thickness. A side-set backlight usually has a larger outline than a liquid crystal unit, which requires that a frame of a display module be provided with a large frame. However, as the demand for portable devices such as notebook computers increases, there is an urgent need for thinner display crystal modules with smaller sizes and higher brightness.

FIG. 1 schematically shows structures opposite a backlight of a display module in the prior art. The backlight unit comprises a sealant frame 22, a reflecting plate 28, a light guide plate 26, and an optical film layer 25. A liquid crystal unit 1 and the backlight unit are fitted together by a bonding adhesive 21. An outline of the backlight unit is much larger than an outline of the liquid crystal unit 1 due to the presence of the sealant frame 22. As shown in FIG. 1, d1 is about 0.2 to 0.3 mm, which renders a bezel of the display module large. In addition, since the liquid crystal unit 1 and the backlight unit are fitted together by the bonding adhesive 21, it is necessary to leave a gap between a lower surface of the liquid crystal unit and an upper surface of the optical film layer 25 in order to prevent wrinkles during display. As shown in FIG. 1, d2 is about 0.08 mm, which undoubtedly increases a thickness of the display module.

Furthermore, due to the presence of the sealant frame 22, a narrow-bezel design can be achieved only by indenting an edge of the light guide plate, which renders a distance d3 between an edge of the light guide plate 26 and an edge of an active area of the liquid crystal unit 1 too small, thus further resulting in a risk of light leakage from the light guide plate. In order to avoid light leakage from the light guide plate, a value of d3 is required to reach 0.5 mm, but the value of d3 in the prior art is far less than 0.5 mm.

### SUMMARY OF THE INVENTION

In order to realize a narrow-bezel and thin display module and to avoid light leakage at edges of a light guide plate, the present disclosure provides a display module and a method for fitting the same.

The display module according to the present disclosure comprises, from one side thereof to another thereof, a backlight unit and a liquid crystal unit that are fitted together by means of a wrapping tape. A first projection line overlaps an outline of the liquid crystal unit. The first projection line is a projection of an outline of the backlight unit on the liquid crystal unit. Preferably, the liquid crystal unit and the backlight unit are fitted together with no gap therebetween.

In the display module, a size of the outline of the backlight unit is the same as a size of the outline of the liquid crystal unit. That is, a size d1 in the prior art where a sealant frame protrudes with respect to the liquid crystal unit no longer exists. Thus, a size of the outline of the display module is reduced, and the narrow-bezel design of a display device is realized. Meanwhile, since the size of the outline of the backlight unit is the same as that of the liquid crystal unit, a distance between the outline of the backlight unit and an edge of the display area is increased, so that light leakage from the backlight unit can be avoided. In particular, when the liquid crystal unit and the backlight unit are fitted together with no gap therebetween, a thickness of the display module is further reduced, and the narrow-bezel and thin design of the display module is realized.

As a further improvement to the present disclosure, the backlight unit comprises a reflecting plate, a light guide plate, and an optical film layer in sequence. The liquid crystal unit and the optical film layer are fitted together with no gap therebetween. A second projection line is located inside an outline of the light guide plate. The second projection line is a projection of an outline line of the optical film layer on the light guide plate. A third projection line is located inside the outline of the light guide plate.

The third projection line is a projection of an outline line of the reflecting plate on the light guide plate. The reflecting plate, the light guide plate, the optical film layer, and the liquid crystal unit are fitted together by attaching a wrapping tape thereto from a surface of the liquid crystal unit away from the optical film layer to a surface of the reflecting plate away from the light guide plate.

Since the reflecting plate and the optical film layer are indented with respect to the outline of the light guide plate, the wrapping tape is only attached along the outlines of the liquid crystal unit and the light guide plate, which facilitates the attaching operation. At the same time, the outline of the light guide plate overlaps the outline of the liquid crystal unit. Thus, a size of the light guide plate is enlarged so that the distance between the edge of the light guide plate and the edge of the active area of the liquid crystal unit is increased and the risk of light leakage from the light guide plate is avoided. In addition, the reflecting plate, the light guide plate, the optical film layer, and the liquid crystal unit of the display module are fitted together by the wrapping tape, and therefore the sealant frame is no longer needed.

As a further improvement to the present disclosure, the liquid crystal unit comprises a first polarizing plate, an array substrate, a color filter, and a second polarizing plate in sequence. The first polarizing plate and the optical film layer are fitted together with no gap therebetween. The backlight unit and the liquid crystal unit are fitted together by attaching the wrapping tape thereto from a surface of the second polarizing plate away from the color filter to the surface of the reflecting plate away from the light guide plate.

In the fitting method, after the reflecting plate, the light guide plate, the optical film layer and the liquid crystal unit are arranged, a fitting process can be finished at a time to obtain the display module needed. Since the backlight unit and the liquid crystal unit are fitted together by the wrapping tape, the sealant frame is no longer needed, and thus the thickness of the display module is greatly reduced.

As a further improvement to the present disclosure, the liquid crystal unit comprises a first polarizing plate, an array substrate, a color filter, and a second polarizing plate in sequence. The first polarizing plate and the optical film layer are fitted together with no gap therebetween. A fourth projection line is located inside an outline of the color filter. The fourth projection line is a projection of an outline of the second polarizing plate on the color filter. In particular, when a distance between the fourth projection line and the outline of the color filter is not less than 0.5 mm, the reflecting plate, the light guide plate, the optical film layer, and the liquid crystal unit are fitted together by attaching the wrapping tape thereto from a surface of the color filter away from array substrate to the surface of the reflecting plate away from the light guide plate.

In the above display module, the wrapping tape is no longer attached onto an upper surface of the liquid crystal unit, but attached onto an upper surface of the color filter. The fitting process also can be finished at a time to obtain the display module needed, Since the backlight unit and the liquid crystal unit are fitted together by the wrapping tape, the sealant frame is no longer needed, and thus the thickness of the display module is greatly reduced.

As a further improvement to the wrapping tape, the wrapping tape is made from aluminum foil or conductive cloth. This kind of wrapping tape can be so thin that it will not affect the thickness of the display module. Because the wrapping tape has good ductility and fitness, and is moistureproof and gasproof, it can be folded and an edge thereof does not tilt. Thus, it is easy to complete the fitting process. Moreover, because of good light-shielding properties of the wrapping tape, the risk of light leakage from the display module is further avoided.

The present disclosure further provides a method for fitting display module described above. The method comprises steps as follows.

The wrapping tape is attached onto the display module from an upper surface of the display module to a lower surface of the display module along an outline of the display module.

The wrapping tape is folded and attached at each corner of the display module to avoid light leakage at a corner.

As a further improvement to the fitting method, tape extension strips are left at corners of the display module, and the tape extension strips are folded and attached onto the corners so as to avoid light leakage from the corners.

The display module is wrapped by the wrapping tape, and the wrapping tape is folded and attached at each corner of the display module. Thus, light leakage from sidewalls and corners of the display module can be avoided, so that a light source is fully used and brightness of the display module is improved.

In summary, in the display module provided by the present disclosure, a sealant frame is no longer used in the backlight unit, for various layers are fitted together by using the wrapping tape. Thus, the size of the outline of the display module is greatly reduced, and a width of the bezel of the display module is also reduced. Moreover, since the backlight unit and the liquid crystal unit are fitted together with no gap therebetween, the thickness of the display module is further reduced, and the narrow-bezel and thin design of the display module is realized.

### BRIEF DESCRIPTION OF THE DRAWINGS

The present disclosure will be described in a more detailed way below based on embodiments and with reference to the accompanying drawings, in which:

FIG. 1 schematically shows structures opposite a backlight of a display module in the prior art;

FIG. 2 schematically shows a structure of a display module according to Embodiment 1 of the present disclosure;

FIG. 3 schematically shows part of a structure of a display device according to Embodiment 1;

FIG. 4 schematically shows a structure of the display module according to Embodiment 2 of the present disclosure;

FIG. 5 schematically shows part of a structure of the display device according to Embodiment 2;

FIG. 6 schematically shows structures of a backlight side of the display module of the present disclosure; and

FIGS. 7a, 7b, 7c show a fitting process at corners with the fitting method of the present disclosure.

In the accompanying drawings, same components use same reference signs. The accompanying drawings are not drawn according to actual proportions.

### DETAILED DESCRIPTION OF THE EMBODIMENTS

The present disclosure will be described in detail below with reference to the accompanying drawings. The terms “upper”, “lower”, “left” and “right” used in the following texts are locations in the drawings, and should not be construed as limiting the present disclosure.

### Embodiment 1

FIG. 2 shows a display module 100 of the present disclosure. The display module 100 comprises a backlight unit and a liquid crystal unit 120 in sequence from bottom to top. The backlight unit comprises a reflecting plate 111, a light guide plate 112, and.

an optical film layer 113 in sequence from bottom to top. The liquid crystal unit 120 is provided on the optical film layer 113. In the present embodiment, the backlight unit no longer includes a sealant frame. A size of the light guide plate 112 can therefore be large. A projection of an outline of the light guide plate 112 on the liquid crystal unit is referred to as a first projection line. The size of the light guide plate 112 may be increased so that the first projection line overlaps an outline of the liquid crystal unit 120, by way of which a distance between the outline of the light guide plate 112 and an edge 140 of an active area of the liquid crystal unit 120 is increased. As a result, a risk of light leakage from the light guide plate 112 can be avoided. At the same time, the optical film layer 113 and the reflecting plate 111 are not allowed to protrude beyond the outline of the light guide plate 112 in order to facilitate attaching of a wrapping tape. A projection of an outline of the optical film layer 113 on the light guide plate 112 is referred to as a second projection line, and a projection of an outline of the reflecting plate 111 on the light guide plate 112 is referred to as a third projection line. The second projection line and the third projection line are located. inside the outline of the light guide plate 112 for easy attaching of the wrapping tape.

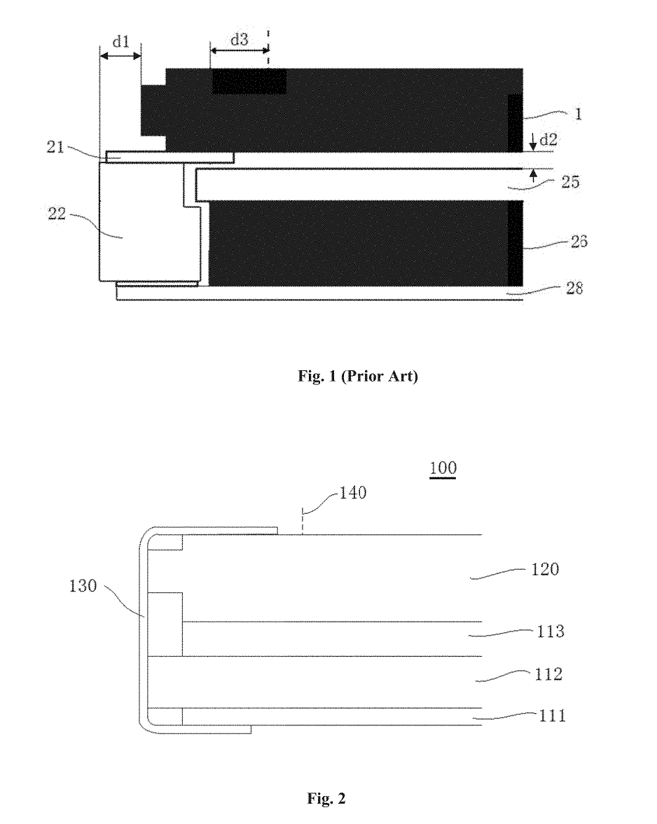

The display module 100 is wrapped by the wrapping tape from a surface thereof to another surface thereof along an outline thereof. That is, a wrapping tape 130 is attached to the display module 100 from an upper surface of the liquid crystal unit 120 to a lower surface of the reflecting plate 111, so that the backlight unit and the liquid crystal unit 120 are fitted together to form an entirety of the display module 100. During an attaching process, preferably, the liquid crystal unit 120 and the optical film layer 113 of the backlight unit are fitted together with no gap therebetween, and thus a thickness of the display module 100 is further reduced. Since the outlines of the optical film layer 113 and the reflecting plate 111 are indented with respect to the outline of the light guide plate 112, the wrapping tape 130 does not contact the optical film layer 113 and the reflecting plate 111, while the wrapping tape 130 is attached from the upper surface of the liquid crystal unit 120 along the outline of the display module 100. The attaching is thus rendered easier. After the attaching process is completed, only a thickness of the wrapping tape 130 is added to the entire outline of the display module 100 based on the outline of the liquid crystal unit 120, whereas the thickness of the wrapping tape is merely about 0.06 mm, which is far less than the thickness d1 which is about 0.2 to 0.3 mm (see FIG. 1 of the prior art). A size of the outline of the display module 100 is thus greatly reduced. As a result, a width of a bezel of the display module 100 is further reduced, and the narrow-bezel design of the display module is realized.

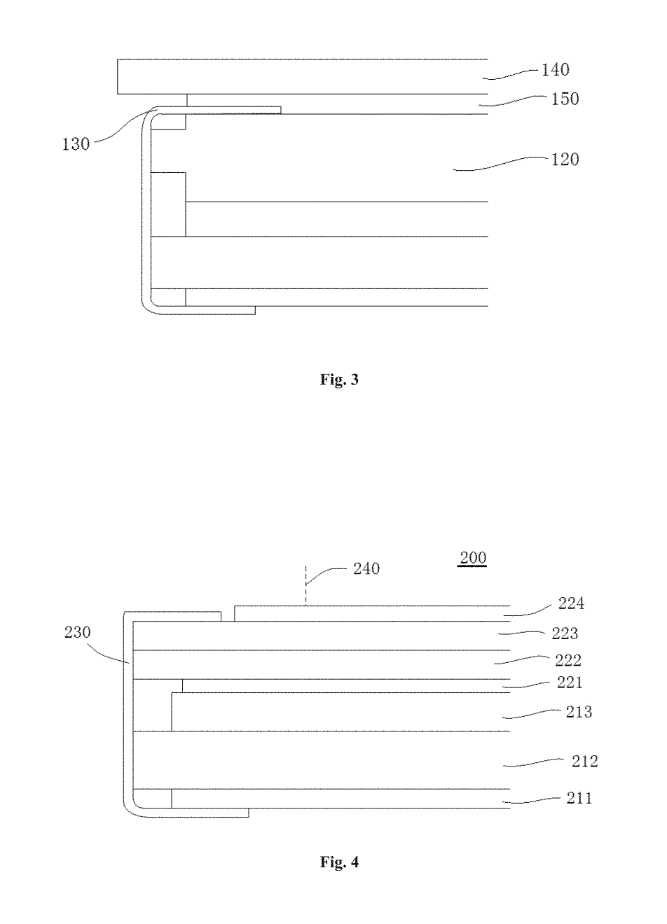

FIG. 3 schematically shows a structure of a display device formed by the display module 100. A glass cover plate 140 is provided over the display module 100, and an optical adhesive 150 is provided between the glass cover 140 and the liquid crystal unit 120. A thickness of the optical adhesive 150 is about 0.15 mm, which is much larger than the thickness of the wrapping tape 130 which is about 0.06 mm. Therefore, the wrapping tape 130 on the liquid crystal unit 120 has no effect on a thickness of the display device.

### Embodiment 2

FIG. 4 schematically shows a structure of a display module 200 according the present embodiment. The display module 200 comprises a backlight unit and a liquid crystal unit in sequence from bottom to top. The backlight unit comprises a reflecting plate 211, a light guide plate 212, and an optical film layer 213 in sequence from bottom to top. The liquid crystal unit comprises a first polarizing plate 221, an array substrate 222, a color filter 223, and a second polarizing plate 224 in sequence. The first polarizing plate 221 of the liquid crystal unit and the optical film layer 213 of the backlight unit are fitted together with no gap therebetween. In the present embodiment, the backlight unit no longer includes a sealant frame. A size of the light guide plate 212 can therefore be large. Preferably, a projection of an outline of the light guide plate 212 on the liquid crystal unit is referred to as a first projection line. The size of the light guide plate 212 may be increased, so that the first projection line overlaps an outline of the liquid crystal unit, by way of which a distance between the outline of the light guide plate 212 and an edge 240 of an active area of the liquid crystal unit is increased. As a result, a risk of light leakage from the light guide plate 212 can be avoided. At the same time, the optical film layer 213 and the reflecting plate 211 are not allowed to protrude beyond the outline of the light guide plate 212 in order to facilitate attaching of a wrapping tape. A projection of an outline of the optical film layer 213 on the light guide plate 212 is referred to as a second projection line, and a projection of an outline of the reflecting plate 211 on the light guide plate 212 is referred to as a third projection line. The second projection line and the third projection line are located inside the outline of the light guide plate 212 for easy attaching of the wrapping tape.

In the present embodiment, a projection of an outline of the second polarizing plate 224 on the color filter 223 is referred to as a fourth projection line, and the fourth projection line is located inside an outline of the color filter 223. Preferably, a distance between the fourth projection line and the outline of the color filter 223 is not less than 0.5 mm, so that a space for the wrapping tape can be left on the color filter.

The display module 200 is wrapped by the wrapping tape from a surface thereof to another surface thereof along the outline thereof. That is, the wrapping tape 230 is attached to the display module 200 from an upper surface of the color filter of the liquid crystal unit to a lower surface of the reflecting plate 211, so that the backlight unit and the liquid crystal unit are fitted together to form an entirety of the display module 200. During an attaching process, preferably, the first polarizing plate 221 of the liquid crystal unit and the optical film layer 213 of the backlight unit are fitted together with no gap therebetween, so that a thickness of the display module 200 is further reduced. Since the outlines of the optical film layer 213 and the reflecting plate 211 are indented with respect to the outline of the light guide plate 212, the wrapping tape 230 does not contact the optical film layer 213 and the reflecting plate 211, while the wrapping tape 230 is attached from the upper surface of the color filter along the outline of the display module 200. The attaching is thus rendered easier. After the attaching process is completed, only a thickness of the wrapping tape 230 is added to the entire outline of the display module 200 based on the outline of the liquid crystal unit 220, whereas the thickness of the wrapping tape 230 is merely about 0.06 mm, which is far less than the thickness d1 which is about 0.2 to 0.3 mm (see FIG. 1 of the prior art). A size of the entire outline of the display module 200 is thus greatly reduced. As a result, a width of a bezel of the display module is further reduced, and the narrow-bezel design of the display module is realized.

FIG. 5 schematically shows a structure of a display device formed by the display module 200. A glass cover plate 240 is provided over the display module 200, and an optical adhesive 250 is provided between the glass cover 240 and the second polarizing plate 224. A thickness of the optical adhesive 250 is about 0.15 mm, which is much larger than the thickness of the wrapping tape 130 which is about 0.06 mm. Therefore, the wrapping tape 230 provided on the liquid crystal unit has no effect on a thickness of the display device.

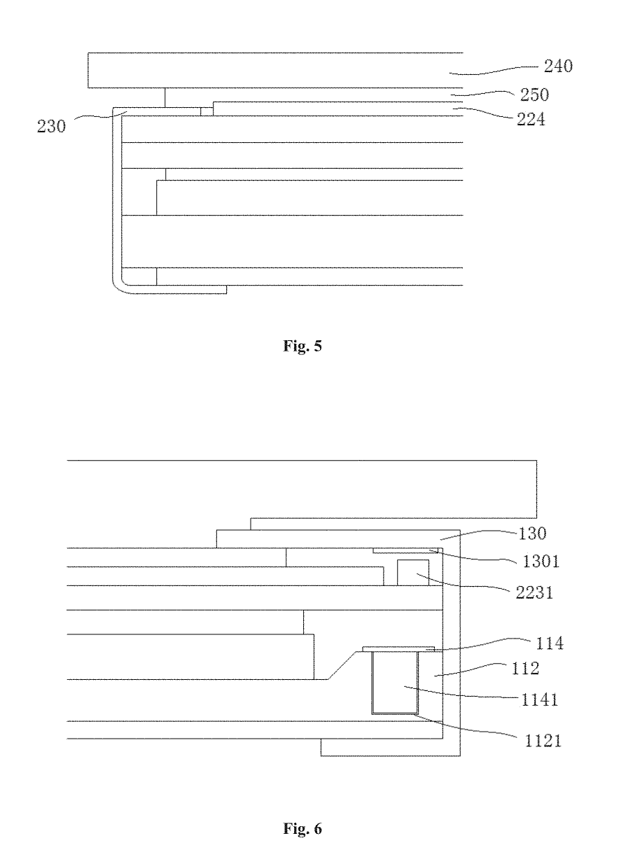

The above two embodiments illustrate the structures opposite the backlight of the display module of the present disclosure and the process of attaching the wrapping tape. FIG. 6 schematically shows structures on a backlight side of the display module in Embodiment 1. On the backlight side of the display module, an LED strip 114 as a light source is fixed on the light guide plate 112 by a double faced adhesive tape. The light guide plate 112 is provided, at a position corresponding to an LED 1141, with a groove 1121 for accommodating an LED. It can thus be ensured that light emitted from the LED 1141 enters the light guide plate 112 sufficiently. The number and location of the groove 1121 can be selected according to the number and location of the LED 1141. Because the wrapping tape is made from aluminum foil or conductive cloth, in order to prevent an IC circuit 2231 from being short-circuited by the wrapping tape 130, a PET film 1301 having a thickness of about 0.03 mm is provided on the wrapping tape at a position corresponding to the IC circuit 2231. The PET film can be arranged at other positions where a short circuit may be caused, thereby preventing the impact of the wrapping tape on the IC circuit.

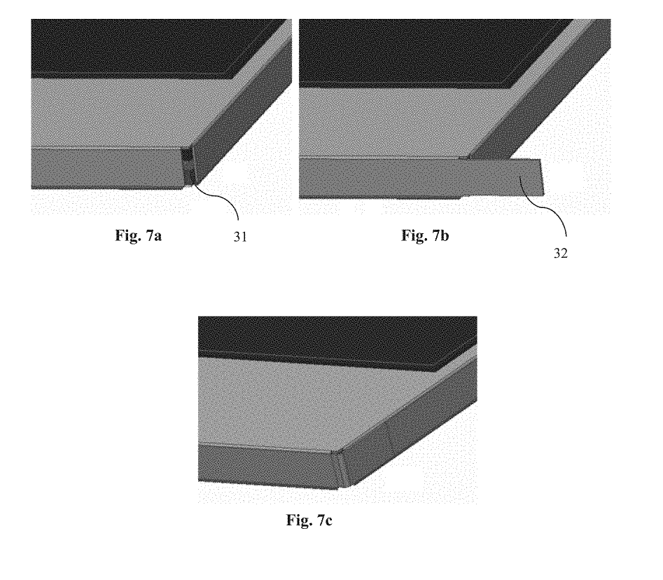

In the process of attaching the wrapping tape, gaps 31 may be formed at corners of the display module with a conventional attaching method, as shown in FIG. 7a. According to the attaching method of the present disclosure, tape extension strips 32 are left at corners of the display module, as shown in FIG. 7b. The tape extension strips 32 are folded and attached at the corners so as to sufficiently bridge the gaps 31 to achieve an effect as shown in FIG. 7c. Thus, light leakage from the corners is avoided.

It should be illuminated that the above embodiments are described only for better understanding, rather than restricting the present disclosure. Although the present disclosure is described in a detailed way with reference to the preferable embodiments, it should be understood that any person skilled in the art can make amendments and equivalent substitutes to the technical solutions of the present disclosure without departing from the spirit and scope of the present disclosure, and the amendments and substitutes shall be covered by the scope as defined in the claims of the present disclosure.

1. A display module, comprising, from one side thereof to another side thereof, a backlight unit and a liquid crystal unit that are fitted together by means of a wrapping tape, wherein:
a first projection line overlaps an outline of the liquid crystal unit, the first projection line being a projection of an outline of the backlight unit on the liquid crystal unit.

2. The display module according to claim 1, wherein the liquid crystal unit and. the backlight unit are fitted together with no gap therebetween.

3. The display module according to claim 2, wherein the backlight unit comprises a reflecting plate, a light guide plate, and an optical film layer in sequence from bottom to top, and the liquid crystal unit and the optical film layer are fitted together with no gap therebetween, wherein:
a second projection line is located inside an outline of the light guide plate, the second projection line being a projection of an outline of the optical film layer on the light guide plate;
a third projection line is located inside the outline of the light guide plate, the third projection line being a projection of an outline of the reflecting plate on the light guide plate; and
the reflecting plate, the light guide plate, the optical film layer, and the liquid crystal unit are fitted together by attaching the wrapping tape thereto from a surface of the liquid crystal unit away from the optical film layer to a surface of the reflecting plate away from the light guide plate.

4. The display module according to claim 3, wherein the liquid crystal unit comprises a first polarizing plate, an array substrate, a color filter, and a second polarizing plate in sequence, wherein:
the first polarizing plate and the optical film layer are fitted together with no gap therebetween; and
the backlight unit and the liquid crystal unit are fitted together by attaching the wrapping tape thereto from a surface of the second polarizing plate away from the color filter to the surface of the reflecting plate away from the light guide plate.

5. The display module according to claim 3, wherein the liquid crystal unit comprises a first polarizing plate, an array substrate, a color filter, and a second polarizing plate in sequence, Wherein the first polarizing plate and the optical film layer are fitted together with no gap therebetween; and
a fourth projection line is located inside an outline of the color filter, the fourth projection line being a projection of an outline of the second polarizing plate on the color filter.

6. The display module according to claim 5, wherein a distance between the fourth projection line and the outline of the color filter is not less than 0.5 mm.

7. The display module according to claim 6, wherein the backlight unit and the liquid crystal unit are fitted together by attaching the wrapping tape thereto from a surface of the color filter away from the array substrate to the surface of the reflecting plate away from the light guide plate.

8. The display module according to claim 1, wherein the wrapping tape is made from aluminum foil or conductive cloth.

9. A method for fitting a display module, comprising steps of:
attaching a wrapping tape onto the display module from an upper surface of the display module to a lower surface of the display module along an outline of the display module; and
folding and attaching the wrapping tape at each corner of the display module to avoid light leakage at a corner,
wherein the display module comprises, from one side thereof to another side thereof, a backlight unit and a liquid unit that are fitted together by means of the wrapping tape; and
wherein a first projection line overlaps an outline of the liquid crystal unit, the first projection line being a projection of an outline of the backlight unit on the liquid crystal unit.

10. The display module according to claim 9, wherein the liquid crystal unit and the backlight unit are fitted together with no gap therebetween.

11. The method according to claim 10, wherein the backlight unit comprises a reflecting plate, a light guide plate, and an optical film layer in sequence from bottom to top, and the liquid crystal unit and the backlight unit are fitted together with no gap therebetween, wherein:
a second projection line is located inside an outline of the light guide plate, the second projection line being a projection of an outline of the optical film layer on the light guide plate;
a third projection line is located inside the outline of the light guide plate, the third projection line being a projection of an outline of the reflecting plate on the light guide plate; and
the reflecting plate, the light guide plate, the optical film layer, and the liquid crystal unit are fitted together by attaching the wrapping tape thereto from a surface of the liquid crystal unit away from the optical film layer to a surface of the reflecting plate away from the light guide plate.

12. The method according to claim 11, wherein, the liquid crystal unit comprises a first polarizing plate, an array substrate, a color filter, and a second polarizing plate in sequence, wherein:
the first polarizing plate and the optical film layer are fitted together with no gap therebetween; and
the backlight unit and the liquid crystal unit are fitted together by attaching the wrapping tape thereto from a surface of the second polarizing plate away from the color filter to the surface of the reflecting plate away from the light guide plate.

13. The method according to claim 11, wherein the liquid crystal unit comprises a first polarizing plate, an array substrate, a color filter, and a second polarizing plate in sequence, wherein the first polarizing plate and the optical film layer are fitted together with no gap therebetween; and
a fourth projection line is located inside an outline of the color filter, the fourth projection line being a projection of an outline of the second polarizing plate on the color filter.

14. The method according to claim 13, wherein a distance between the fourth projection line and the outline of the color filter is not less than 0.5 mm.

15. The method according to claim 14, wherein the backlight unit and the liquid crystal unit are fated together by attaching the wrapping tape thereto from a surface of the color filter away from the array substrate to the surface of the reflecting plate away from the light guide plate.

16. The method according to claim 9, wherein tape extension strips are left at corners of the display module, and the tape extension strips are folded and attached onto the corners so as to avoid light leakage from the corners.
